(19) United States
(12) Patent Application Publication
(10) Pub. No.: US 2021/0231487 A1
(43) Pub. Date: Jul. 29, 2021

(54) METHOD FOR ELIMINATING PUMP NOISE BY EMPIRICAL MODE DECOMPOSITION AND PARTICLE SWARM OPTIMIZATION

(71) Applicant: ZHEJIANG UNIVERSITY, Hangzhou City (CN)

(72) Inventors: Fengzhong QU, Hangzhou City (CN); Qin JIANG, Hangzhou City (CN); Yusen ZHANG, Hangzhou City (CN); Guozheng JIN, Hangzhou City (CN); Jingchen ZHANG, Hangzhou City (CN); Zhujun ZHANG, Hangzhou City (CN); Yezhou WU, Hangzhou City (CN)

(21) Appl. No.: 17/232,162

(22) Filed: Apr. 16, 2021

Related U.S. Application Data
(63) Continuation of application No. PCT/CN2019/103602, filed on Aug. 30, 2019.

(30) Foreign Application Priority Data
Oct. 17, 2018 (CN) 201811210824.6

(51) Int. Cl. G01H 3/10; G06K 9/00; G06N 3/00

(52) U.S. Cl. CPC G01H 3/10; G06N 3/006; G06K 9/0051

(57) ABSTRACT

A method for eliminating pump noise by empirical mode decomposition and particle swarm optimization is provided. In the method, based on a hypothesis of the pump noise being a linear combination of a group of bases, an extracted pump noise sample is decomposed into a group of signals as bases by the empirical mode decomposition. Coefficients of the optimized linear combination of the group of bases is determined by the particle swarm optimization, thus updating the pump noise sample and improving a noise elimination effect. During a limited number of noise elimination periods, a current pump noise sample is modified by weighting, such that in a limited number of iterations, the current pump noise sample gradually converges to the pump noise waveform in the unit of a varied period, so as to be applicable to a slow variation of the pump noise during a long-time operation of the system.

### CROSS-REFERENCE TO RELATED APPLICATIONS

This application is a continuation of International Application No. PCT/CN2019/103602, filed on Aug. 30, 2019, which claims priority to Chinese Patent Application No. 201811210824.6, filed on Oct. 17, 2018, the content of which are incorporated herein by reference in their entireties.

### TECHNICAL FIELD

The application relates to a technical field of wireless measurement while drilling, and particularly to a method for eliminating pump noise by empirical mode decomposition (EMD) and particle swarm optimization (PSO).

### BACKGROUND

Currently, in a wireless measurement while drilling system, mud pulse telemetry has been widely used on the world scale. A mud pulse is obtained by converting data measured by a downhole instrument into electrical signals, converting the electrical signals into pressure wave signals under the action of the mud pump, and then transmitting the converted pressure wave signals to the ground by a medium of mud. The mud pulse has a high reliability and can be used to implement a remote transmission, which conforms to the actual situations of well drilling. Thus, the mud pulse telemetry is a general transmission way domestically. In the process of signal transmission by mud, the piston of the mud pump is needed to perform a reciprocating motion constantly, which may result in periodical pump noise. Therefore, the pump noise should be eliminated from the mud pulse signal, and then the mud pulse signal can be encoded correctly. The mud pulse communication system is a time-variant system. With the increase of drilling depth, mud channel parameters including pump noise properties may vary continuously. A hypothesis that the pump noise is periodical is constructed based on a similarity hypothesis in a time window with a limited length. With the increase of an operation time of the system, a difference between the obtained pump noise sample and a waveform of the pump noise in the unit of period will be increased, leading to an increase of residue noise in the output in which the noise is eliminated, and deteriorating a noise elimination effect.

### SUMMARY

In view of the shortages of the existing technology, an objective of the application is to provide a method for eliminating pump noise by empirical mode decomposition and particle swarm optimization. In the present application, the pump noise sample is continuously updated by the empirical mode decomposition and the particle swarm optimization, so as to improve a pump noise elimination effect.

The objective of the present application can be achieved by the following technical solution. A method for eliminating pump noise by empirical mode decomposition and particle swarm optimization is provided. The method includes:

step (1), obtaining a pressure signal measured by a sensor and performing a low-pass filtering to the pressure signal, to obtain a mud pressure signal in which a part of white noise is filtered out;

step (2), obtaining a period T of a pump noise signal by using a pump stroke signal measured by a pump stroke sensor as a time reference;

step (3), segmenting the mud pressure signal in step (1) at a time interval of the period T in the step (2), to obtain a plurality of segmented signals; and summing up signals in each of the plurality of segmented signals and calculating an average for each of the plurality of segmented signals, to obtain an empirical waveform p(m) with an average closest to an actual waveform of periodical pump noise in a single period as a pump noise sample;

step (4), performing a mode decomposition to the pump noise sample, to obtain a group of bases for constructing the pump noise; and

step (5), determining a coefficient of an optimized linear combination of the group of bases by the particle swarm optimization, to update the pump noise sample.

Further, the step (5) includes: in the particle swarm optimization, initializing weight coefficients to be 1; initializing particle swarm optimization parameters, where the particle swarm optimization parameters include an upper limit of each of weight coefficients, a lower limit of each of the weight coefficients, a particle number and maximum iterations; and performing encoding iteration; where the encoding iteration includes: encoding a received signal, from which the empirical waveform of the pump noise is subtracted, to perform an equalization decision; calculating a mean square value (MSE) as an output feedback parameter; each time an iteration is performed with an optimization algorithm, multiplying updated weight coefficients by respective bases to obtain multiple products, and summing up the products to obtain an updated empirical waveform; calculating MSE as a cost function for a next iteration by the same steps, until the maximum iterations are reached or a stopping criterion for the iteration is satisfied; multiplying final weight coefficients by the respective bases, to obtain an optimized empirical waveform by eliminating the pump noise from the received signal; and outputting a final encoding symbol, wherein the MSE is calculated by the following equation:

$$〈 w 〉 = arg {min}_{( w )} \{ \frac{1}{N} {\sum }_{i = 1}^{N} {\vert {d}_{i} - {\hat{y}}_{i} \vert}^{2} \}$$

where w is a weight coefficient vector for the respective bases, N is the number of symbols for a noise elimination, dᵢ is a decision value for the i th symbol, and ŷᵢ is an estimated value of the i th symbol; where a physical meanings of MSE represents an error power of an encoded output; and in the particle swarm optimization, a travailing direction of particles is determined according to a changing trend of the MSE, thereby obtaining optimized weight coefficients and improving a noise elimination effect.

One of advantages of the present application is as follows. In the method for eliminating the pump noise by EMD and PSO according to the present application, a basic idea is that the pump noise is considered as a linear combination of a group of bases, and the updating process of the pump noise includes: determining an optimized linear combination of the group of bases according to the decision output. Here, in EMD, the pump noise simply is decomposed into a group of bases which may be used to reconstruct a waveform estimation closer to actual pump noise. In addition, for any group of bases constructing the pump noise, it is possible to obtain a coefficient of an optimized linear combination of this group as an updating mechanism for the pump noise sample, by using the PSO. In the present application, during a limited number of noise elimination periods, a current pump noise sample is modified in a manner of weighting, such that in a limited number of iterations, the current pump noise sample gradually converges to the pump noise waveform in the unit of a varied period, so as to be applicable to a slow variation of the pump noise during a long-time operation of the system.

### BRIEF DESCRIPTION OF DRAWINGS

FIG. 1 is a structure diagram of a method for eliminating pump noise based on EMD and PSO;

FIG. 2 is a schematic diagram of a pressure signal of a sensor;

FIG. 3 is a schematic diagram of a pump stroke signal;

FIG. 4 is a schematic diagram of a pump noise sample obtained by a coherent averaging method;

FIG. 5 is an oscillogram for each signal obtained by decomposing a pump noise sample with EMD;

FIG. 6 is a schematic diagram of an output signal after a noise elimination; and

FIG. 7 is an enlarged schematic diagram of an output signal after a noise elimination.

### DESCRIPTION OF EMBODIMENTS

Further description is made in connection with accompanying drawings and detailed embodiments. However, embodiments and a protection scope of the present application are not limited hereto.

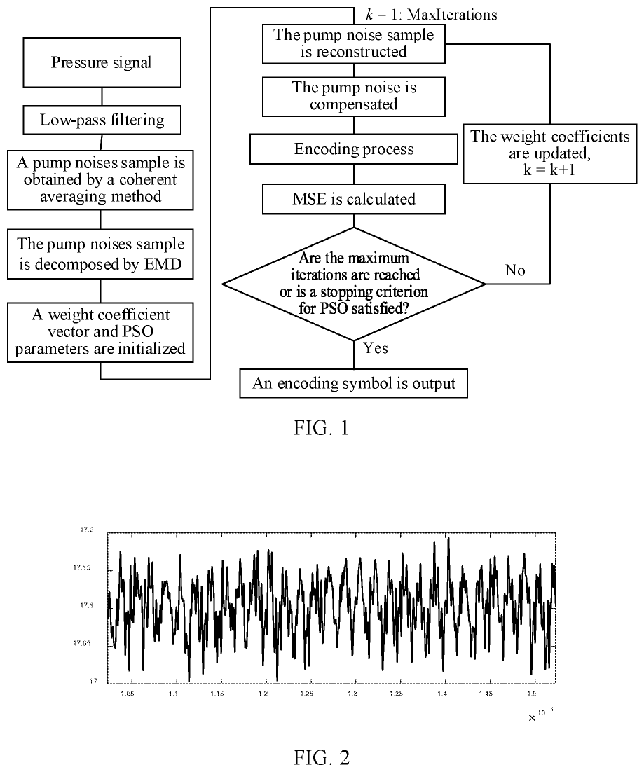

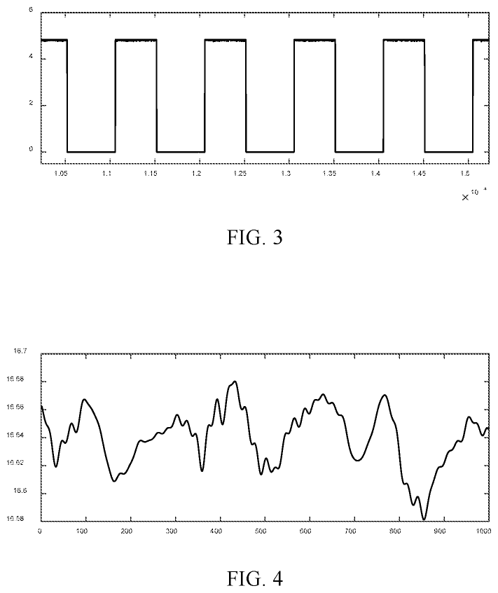

FIG. 1 is a structure diagram of a method for eliminating pump noise based on EMG and PSO. As shown in FIG. 1, a low-pass filtering is firstly performed to a pressure signal measured by a downhole sensor, and an empirical waveform of the pump noise is extracted by a coherent averaging method. After that, the pump noise sample is updated with an iterative method based on EMD in combination with PSO, until the waveform conforms to an actual noise waveform. In the embodiment, a part of actual well dual-pump data is selected as the pressure signal, and the waveform thereof is shown as FIG. 2. Two pumps in the dual-pump have base frequencies of 0.994 Hz and 1 Hz respectively, a code rate of 3 bps and a depth of 2890, which is in a modulation mode of FSK.

After the measured pressure signal is obtained from the sensor, a performance index for a low-pass filter is determined according to pressure data properties. The low-pass filtering is performed on the pressure signal by the low-pass filter, to obtain a mud pressure signal in which a part of white noise is filtered out.

Then, a pump stroke signal as shown in FIG. 3 is introduced as a time reference, to obtain a period T of the pump noise signal. The pump stroke signal is measured by a pump stroke sensor. The pump stroke sensor is a displacement sensor or a travel switch installed in a mud pump, which is used to record position information of a piston of the mud pump. Taking the travel switch being the pump stroke sensor as an example, the output of the pump stroke sensor is generally a sequence of on-off quantity constructed by a group of rectangular pulses. A low level represents that the travel switch is not triggered, while a high level represents that the travel switch is triggered. A rising edge of each rectangular pulse corresponds to a moment when the piston reaches the travel switch. The pressure signal is segmented at a time interval of the period T to obtain multiple segmented signals. The signals in each of segmented signals are summed up to calculate an average for each of the plurality of segmented signals. In the case that the summing is performed enough times, an empirical waveform with the obtained average closest to the actual waveform of a periodical pump noise in a single period is the pump noise sample as shown in FIG. 4.

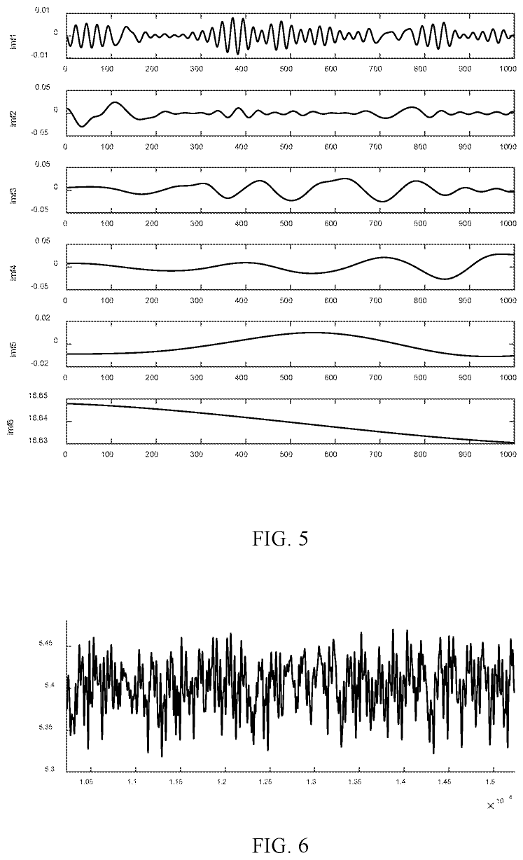

A mode decomposition is performed to the pump noise sample, to obtain a group of bases constructing the pump noise and a coefficient for the group of bases as shown in FIG. 5.

In the particle swarm optimization, weight coefficients are initialized to be 1. PSO parameters such as upper and lower limits of each of the weight coefficients, a particle number, and maximum iterations are initialized, and then an iteration is performed for encoding. Encoding is performed on a received signal, from which the empirical waveform of the pump noise is subtracted, to perform an equalization decision. A mean square value (MSE) is calculated as an output feedback parameter. Each time the iteration is performed with the optimization, updated weight coefficients are multiplied by respective bases, and then the obtained products are summed up to obtain an updated empirical waveform. MSE is calculated by the same steps as a cost function for the next iteration, until the maximum iterations are reached or a stopping criterion for iteration is satisfied. Final weight coefficients are multiplied by the respective bases, to obtain an optimized empirical waveform by eliminating the pump noise from the received signal; and outputting a final encoding symbol. MSE is calculated by the following equation:

$$〈 w 〉 = arg {min}_{( w )} \{ \frac{1}{N} {\sum }_{i = 1}^{N} {\vert {d}_{i} - {\hat{y}}_{i} \vert}^{2} \}$$

where w is a weight coefficient vector for the respective bases, N is a number of symbols for the noise elimination, dᵢ is a decision value for the i th symbol, and ŷᵢ is an estimated value of the i th symbol; where a physical meanings of MSE represents an error power of an encoded output; and in the particle swarm optimization, a travailing direction of particles is determined according to a changing trend of MSE, thereby obtaining optimized weight coefficients and improving a noise elimination effect.

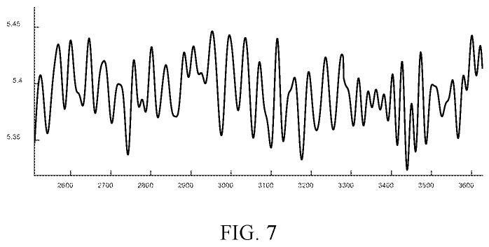

In this embodiment, the output of the noise elimination obtained after the particle convergence is shown in FIG. 6, while FIG. 7 is an enlarged schematic diagram thereof. As shown in the FIGS. 6 and 7, the signal frequency after the noise elimination is relatively obvious and is easy to be identified. Thus, the noise is eliminated effectively.

In conclusion, in the method provided by the embodiments of the application, it is possible to effectively eliminate the pump noise in a case of single pump or dual-pump with the same frequency. Compared to the existing technology, the method of the application can be performed in a time domain, which provides an available solution for eliminating periodical pump noise. In addition, the method is applicable to variations of the pump noise during a long-time operation of the system, thus increasing an encoding accuracy.

What is claimed is:

1. A method for eliminating pump noise by empirical mode decomposition (EMD) and particle swarm optimization (PSO), comprising:
step (1), obtaining a pressure signal measured by a sensor and performing a low-pass filtering to the pressure signal, to obtain a mud pressure signal in which a part of white noise is filtered out;
step (2), obtaining a period T of a pump noise signal by using a pump stroke signal measured by a pump stroke sensor as a time reference;
step (3), segmenting the mud pressure signal in step (1) at a time interval of the period T in the step (2) to obtain a plurality of segmented signals; and summing up signals in each of the plurality of segmented signals and calculating an average for each of the plurality of segmented signals, to obtain an empirical waveform p(m) with an average closest to an actual waveform of periodical pump noise in a single period as a pump noise sample;
step (4), performing a mode decomposition to the pump noise sample, to obtain a group of bases for constructing the pump noise; and
step (5), determining a coefficient of an optimized linear combination of the group of bases by the particle swarm optimization, to update the pump noise sample.

2. The method for eliminating pump noise by EMD and PSO according to claim 1, wherein the step (5) comprises: in the particle swarm optimization, initializing weight coefficients to be 1, initializing PSO parameters, and performing encoding iteration; wherein the encoding iteration comprises:
encoding a received signal, from which the empirical waveform of the pump noise is subtracted, to perform an equalization decision; calculating a mean square value (MSE) as an output feedback parameter; and each time an iteration is performed with an optimization algorithm, multiplying updated weight coefficients by respective bases to obtain a plurality of products, and then summing up the obtained products to obtain an updated empirical waveform; and
calculating the MSE by the same steps as a cost function for a next iteration, until maximum iterations are reached or an stopping criterion for the iteration is satisfied;
multiplying final weight coefficients by the respective bases, to obtain an optimized empirical waveform by eliminating the pump noise from the received signal; and outputting a final encoding symbol, wherein the MSE is calculated by following equation:
$$〈 w 〉 = arg {min}_{( w )} \{ \frac{1}{N} {\sum }_{i = 1}^{N} {\vert {d}_{i} - {\hat{y}}_{i} \vert}^{2} \}$$
wherein w is a weight coefficient vector for the respective bases, N is the number of symbols for a noise elimination, dᵢ is a decision value for the i th symbol, and ŷᵢ is an estimated value of the i th symbol; and wherein a physical meanings of MSE represents an error power of an encoded output; and in the particle swarm optimization, a travailing direction of particles is determined according to a changing trend of the MSE, thereby obtaining optimized weight coefficients and improving a noise elimination effect.

3. The method for eliminating pump noise by EMD and PSO according to claim 2, wherein the particle swarm optimization parameters comprise an upper limit of each of the weight coefficients, a lower limit of each of the weight coefficients, a particle number and maximum iterations.
